(19) United States
(12) Patent Application Publication
(10) Pub. No.: US 2012/0297661 A1
(43) Pub. Date: Nov. 29, 2012

(54) MOUSETRAP AND METHOD

(76) Inventor: Michael Hansen, Lehi, UT (US)

(21) Appl. No.: 13/113,921

(22) Filed: May 23, 2011

(51) Int. Cl. A01M 23/30

(52) U.S. Cl. 43/81.5

(57) ABSTRACT

An apparatus and method are disclosed for improved operation and functionality of a spring-loaded mousetrap. The improved mousetrap comprises two hooks in place of the standard trigger for engaging a Cheerio. Alternative embodiments comprise alligator clips. The mousetrap is baited with a Cheerio, and primed by using the Cheerio and hooks or alligator clips to hold down the locking lever of the mousetrap. When the Cheerio is nibbled by a mouse, the Cheerio breaks with tensile force applied by the primed locking lever, and the jaw snaps forward, killing the mouse.

### FIELD OF THE INVENTION

This invention relates to mousetraps, and more particularly relates to improved spring-loaded mousetraps designed to prevent mice from stealing bait from a primed mousetrap without activating the mousetrap.

### BACKGROUND

### Description of the Related Art

Standard spring-loaded mousetraps have been known in the art since at least 1894. These spring-loaded mousetraps comprise a board, or body, with a jaw (i.e. striker), a locking lever, a spring and a trigger mounted above a body of the mousetrap.

Typically, the mousetrap is baited with cheese, bread, meat, butter, peanut butter, or another edible, placed on the trigger. The mousetrap is primed by locking a locking lever over the open spring-loaded jaw, with the jaw set to snap forward on a mouse eating the bait and moving the trigger in consequence.

Typical mousetrap embodiments suffer from a weakness, which is that the trigger must generally be pushed in a single lateral direction to activate the mousetrap. If a mouse approaches the bait from the wrong direction, or pushes or pulls the bait off the trigger in a forward or rearward direction, the mouse may successfully take or steal the bait without activating the trap.

For this reason, traditional mousetraps are not entirely effective at killing and eradicating mice from human dwellings and other structures. What is needed is an improved spring-loaded mousetrap which activates itself anytime the bait is removed, regardless of how the removal is effectuated, and method of more effectively killing mice.

### SUMMARY

From the foregoing discussion, it should be apparent that a need exists for an apparatus and method for more effectively killing mice. Beneficially, such an apparatus and method would incorporate a trigger mechanism configured to activate the mousetrap no matter how the bait is removed.

The present invention has been developed in response to the present state of the art, and in particular, in response to the problems and needs in the art that have not yet been fully solved by currently available mousetraps. Accordingly, the present invention has been developed to provide an apparatus and method for killing mice that overcomes many or all of the above-discussed shortcomings in the art.

The apparatus is provided with a plurality of components or modules configured to impart the necessary functionality to apparatus. The improved spring-loaded mousetrap comprises: a board with a planar top surface and planar bottom surface, the board longer in length across its longitudinal axis, the board shorter in length across the board's lateral axis; a spring-loaded jaw hingedly affixed to the center of the board with reference to the board's longitudinal axis; and a locking lever for securing the jaw in its primed position, the locking lever centrally disposed on the board with reference to the board's lateral axis, the locking lever affixed at one end to a first loop affixed to the top surface of the board, the locking lever affixed at an opposing end to a first hook.

The first hook comprises a rigid hook for gripping a brittle piece of bait, the first hook fulcrumally affixed to the locking lever. The mousetrap further comprises a second loop affixed to one longitudinal end of the board, the second loop fulcrumally affixed to a second hook; and the second hook comprising a rigid hook for gripping a brittle piece of bait such that when the bait is broken or removed from the primed mousetrap, the locking lever is released and the spring-loaded jaw snaps forward on a mouse, the second hook fulcrumally affixed to the locking lever.

The brittle piece of bait may comprise a Cheerio. The first hook and second hook may be formed to grip the inside of the Cheerio and pull the Cheerio with diametrically opposed tensile forces created by upward pressure on the locking lever from the jaw.

A method of killing a mouse is disclosed, the steps of said method comprising: acquiring a spring-loaded mousetrap; removing the trigger from the spring-loaded mousetrap; replacing the trigger with two hooks for securing a brittle piece of bait, the two hooks comprising a first hook and second hook, the first hook fulcrumally affixed to the locking lever, the second hook fulcrumally affixed to one of the body of the mousetrap and a loop affixed to a body of the mousetrap; and baiting the mousetrap with a brittle piece of bait mounted by and between the two hooks, the two hooks applying diametrically opposed tensile forces to the brittle piece of bait when the mousetrap is primed.

The steps of the method further comprise priming the mousetrap by locking a jaw of the mousetrap in an open position; waiting for a mouse to chew or remove the brittle piece of bait; and allowing the jaw to snap forward killing the mouse.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side elevational perspective view of one embodiment of an improved mousetrap in accordance with the present invention;

FIG. 2A is an exploded top elevational perspective view of another embodiment of an improved mousetrap in accordance with the present invention;

FIG. 2B is an exploded top elevational perspective view of another embodiment of an improved mousetrap in accordance with the present invention;

FIG. 3 is a side perspective view of another embodiment of an improved mousetrap in accordance with the present invention; and

FIG. 4 is process flow chart of the steps of a method for killing a mouse in accordance with the present invention.

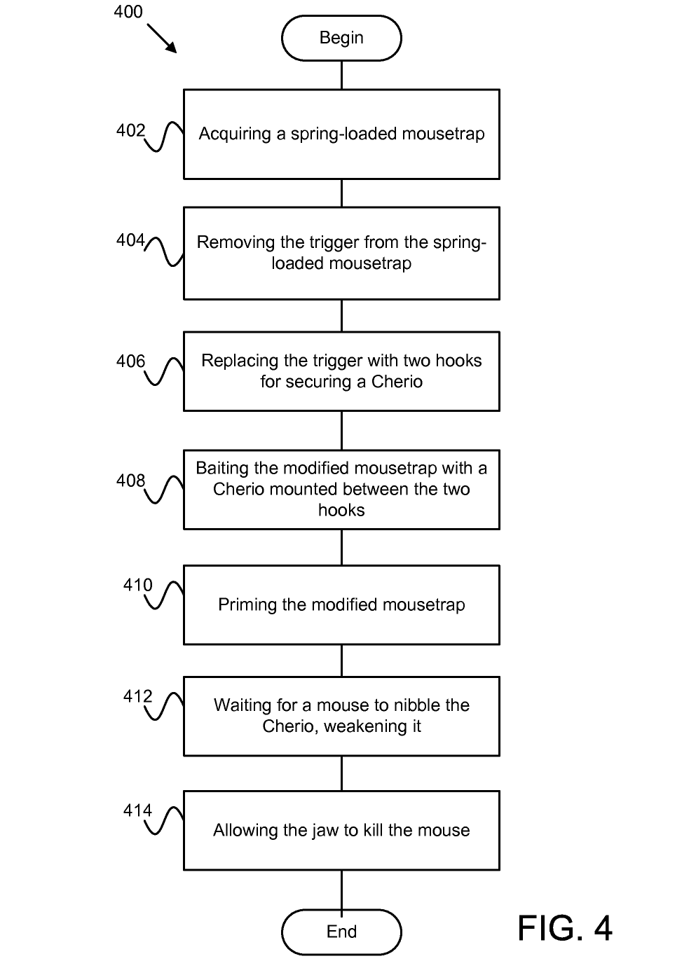

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method.

Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

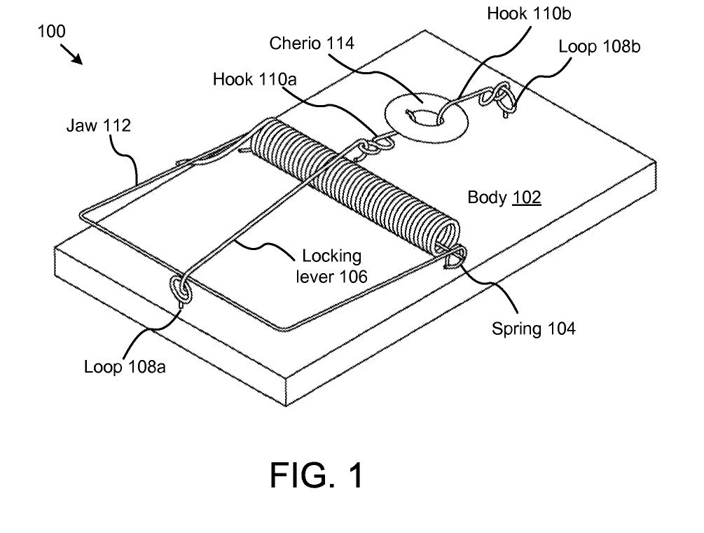

FIG. 1 is a side elevational perspective view of one embodiment of an improved mousetrap 100 in accordance with the present invention. The mousetrap 100 comprises a body 102, a spring 104, a locking lever 106, a loop 108a, a loop 108b, a hook 110a, a hook 110b, a jaw 112, and Cheerio 114.

The body 102, the spring 104, the locking lever 106, the loop 108a, the loop 108b, and a jaw 112 are well-known to those of skill in the art, and are common components in conventional spring-loaded mousetraps.

Typical spring-loaded mousetraps further comprise a trigger, which is not included in the shown embodiment. In the shown embodiment, the trigger is replaced by two hooks 110a-b. The hooks may comprise rigid wire or cable bent or tied into position, or may alternatively comprise clasps or hook fabricated from polymers, woods, alloys or metals.

The hook 110a is affixed in U-joint like fashion to the locking lever 106.

The hook 110b is affixed in U-joint like fashion to the loop 108b. In alternative embodiments, the hook 110b is affixed to the body 102.

The shown embodiment comprises a traditional mousetrap with the hooks 110a-b and the loop 108 added in place of the trigger.

The loop 108b is affixed to one end of the mousetrap 100 on the top planar surface of the mousetrap 100.

The body 102 comprises a planar board made of wood, metals or polymers, and serves as a frame or chassis for the other mechanical components of the mousetrap 100.

The mousetrap 100 is primed by forcing the spring-loaded jaw 112 into its open position as shown, and locking the locking lever 106 across the jaw 112 such that the locking lever 106 is only released when the Cheerio 114 is broken or removed.

The mousetrap 100 is baited by mounting the Cheerio 114 between the hooks 110a-b. In other embodiments of the present invention, other types of brittle pieces of bait may be substituted for the Cheerio, including Fritos, dog food, chips, pretzels, dryed cheese, meat, and other edibles.

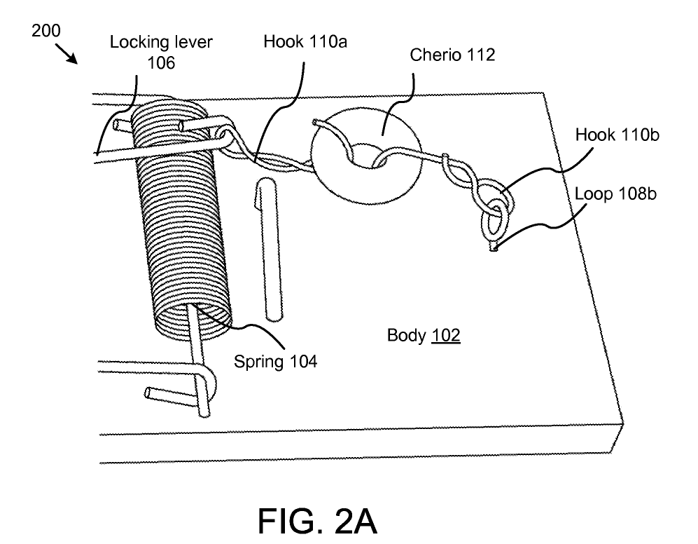

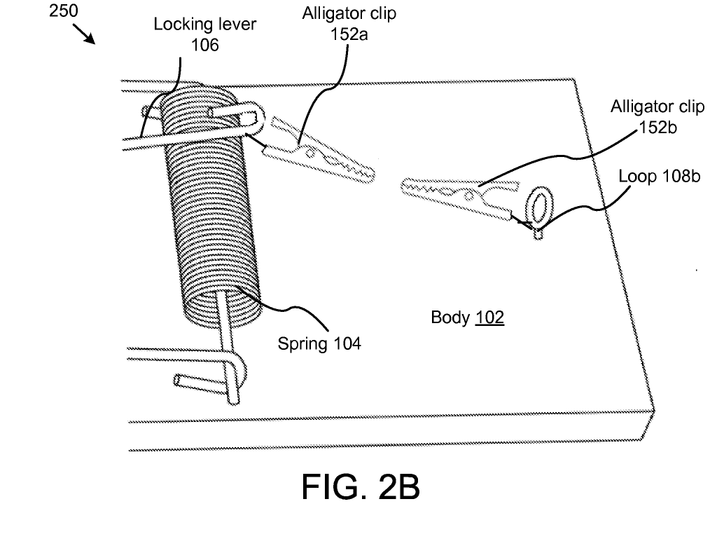

FIG. 2A is an exploded top elevational perspective view of another embodiment of an improved mousetrap 200 in accordance with the present invention. The mousetrap 200 comprises a body 102, a spring 104, a locking lever 106, a loop 108b, a hook 110a, a hook 110b, and Cheerio 114.

Each of the shown components are substantially described above in relation to FIG. 1.

As shown, the hooks 110a-b may comprise stiff wire, from gauge 50 to 2, twisted, tied or bent into shape.

The spring-loaded jaw 112 is hingedly affixed to the center of the body 102 with reference to the body's 102 longitudinal axis, which the axis traversing the body 102 from the loop 108a to the loop 108b.

The locking lever 106 for securing the jaw 112 in its primed position, the locking lever 106 centrally disposed on the body 102 with reference to the body's 102 lateral axis, which is the axis traversing the body 102 parallel to the spring 104, or orthogonal to the direction of tensile force applied to the Cheerio 114.

The locking lever 106 is affixed at one end to the first loop 108a and affixed to the top surface of the body 102. The locking lever 106 is affixed at an opposing end to the first hook 110a.

FIG. 2B is an exploded top elevational perspective view of another embodiment of an improved mousetrap 250 in accordance with the present invention. The mousetrap 200 comprises a body 102, a spring 104, a locking lever 106, an alligator clip 152a, and an alligator clip 152b.

The body 102, spring 104, and locking lever 106 are all substantially described above in relation to FIGS. 1-2A.

In the shown embodiment, a brittle piece of bait is secured with alligator clips 152a-b instead of hooks 110a-b. The alligator clips 152a—are secured to the components of the mousetrap 250 in the same fashion as the hooks 110a-b.

In still further embodiments of the present invention, the mousetrap 250 may comprise other types of clips, including binder clips, jubilee clips, cloths pins, butterfly clutches, or evens screws, bolts, buckles, rubber bands, cage nuts, and the like.

In alternative embodiments of the present invention, the brittle piece of bait is held within a clamp (not shown) by compressive forces, such that when the brittle piece of bait is removed, the clamp collapses and the mousetrap 250 is sprung.

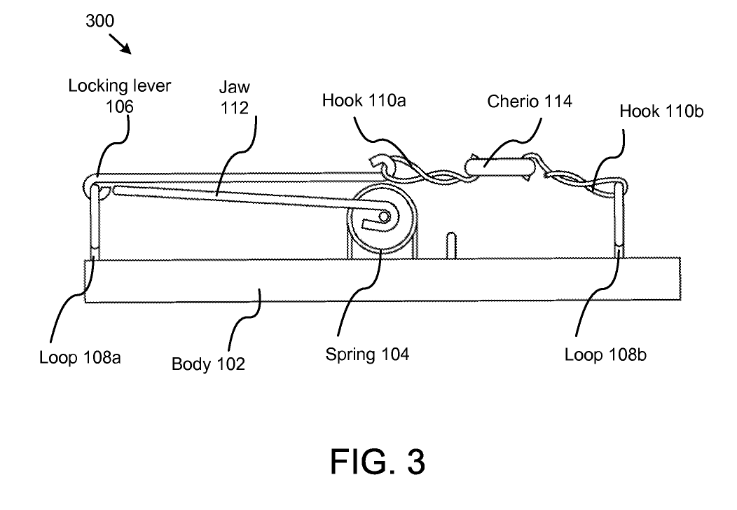

FIG. 3 is a side perspective view of another embodiment of an improved mousetrap 300 in accordance with the present invention. The mousetrap 300 comprises a body 102, a spring 104, a locking lever 106, a loop 108a, a loop 108b, a hook 110a, a hook 110b, a jaw 112, and Cheerio 114.

Each of the shown components are substantially described above in relation to FIGS. 1-2.

Configured as shown, there is no way for the Cheerio 114 to be removed from the mousetrap 300 without activating the primed mousetrap 300. Even if the Cheerio is nibbled, but not entirely removed, the nibbling will weaken the Cheerio 114 such that the tensile forces being applied by the hooks 110a-b to the Cheerio 114 result in its breakage and consequent activation of the mousetrap 300.

The method 400 begins with acquiring 402 a traditional spring-loaded mousetrap from a manufacturer, retailer or supplier. The mousetrap may be missing the trigger, or may be manufactured with hooks 110a-b.

The method 400 progresses by removing 404 the trigger from the spring-loaded mousetrap if the mousetrap has a trigger.

The method 400 progresses by replacing 406 the trigger with two hooks 110a-b for securing a brittle piece of bait, the two hooks 110a-b comprising a first hook and second hook, the first hook fulcrumally affixed to the locking lever, the second hook fulcrumally affixed to one of the body of the mousetrap and a loop affixed to a body of the mousetrap.

The method 400 progresses by baiting 408 the mousetrap with a brittle piece of bait 114 mounted by and between the two hooks 110a-b, the two hooks 110a-b applying diametrically opposed tensile forces to the brittle piece of bait 114 when the mousetrap is primed.

The method 400 progresses with priming 410 the mousetrap by locking a jaw 112 of the mousetrap in an open position. Next, the method 400 progresses with waiting 412 for a mouse to chew or remove the brittle piece of bait 114, and finally the method 400 concludes with allowing 414 the jaw 112 to snap forward killing the mouse.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An improved spring-loaded mousetrap, the mousetrap comprising:
a board with a planar top surface and planar bottom surface, the board longer in length across the board's longitudinal axis, the board shorter in length across the board's lateral axis;
a spring-loaded jaw hingedly affixed to the center of the board with reference to the board's longitudinal axis;
a locking lever for securing the jaw in its primed position, the locking lever centrally disposed on the board with reference to the board's lateral axis, the locking lever affixed at one end to a first loop affixed to the top surface of the board, the locking lever affixed at an opposing end to a first hook;
the first hook comprising a rigid hook for gripping a brittle piece of bait, the first hook fulcrumally affixed to the locking lever;
a second loop affixed to one longitudinal end of the board, the second loop fulcrumally affixed to a second hook; and
the second hook comprising a rigid hook for gripping a brittle piece of bait such that when the bait is broken or removed from the primed mousetrap, the locking lever is released and the primed, spring-loaded jaw snaps forward on a mouse, the second hook fulcrumally affixed to the locking lever.

2. The mousetrap of claim 1, wherein the brittle piece of bait comprises a Cheerio.

3. The mousetrap of claim 2, wherein the first hook and second hook are formed to grip the inside of the Cheerio and pull the Cheerio with diametrically opposed tensile forces created by upward pressure on the locking lever from the jaw.

4. An improved spring-loaded mousetrap, the mousetrap comprising:
a board with a planar top surface and planar bottom surface, the board longer in length across the board's longitudinal axis, the board shorter in length across the board's lateral axis;
a spring-loaded jaw hingedly affixed to the center of the board with reference to the board's longitudinal axis;
a locking lever for securing the jaw in its primed position, the locking lever centrally disposed on the board with reference to the board's lateral axis, the locking lever affixed at one end to a first loop affixed to the top surface of the board, the locking lever affixed at an opposing end to a first hook;
the first clip for gripping a brittle piece of bait, the first clip fulcrumally affixed to the locking lever;
a second clip for gripping a brittle piece of bait fulcrumally affixed to a second loop, the second loop affixed to a longitudinal end of the board; the second clip designed such that when the bait is broken or removed from the primed mousetrap, the locking lever is released and the primed, spring-loaded jaw snaps forward on a mouse.

5. The mousetrap of claim 4, wherein the brittle piece of bait comprises a Cheerio.

6. The mousetrap of claim 4, wherein the first clip and second clip comprise one of an alligator clip, a binder clip, a jubilee clip, a cloths pin, a butterfly clutch, a rubber band, and a cage nut.

7. A method of killing a mouse, the steps of said method comprising:
acquiring a spring-loaded mousetrap;
removing the trigger from the spring-loaded mousetrap;
replacing the trigger with two hooks for securing a brittle piece of bait, the two hooks comprising a first hook and second hook, the first hook fulcrumally affixed to the locking lever, the second hook fulcrumally affixed to one of the body of the mousetrap and a loop affixed to a body of the mousetrap;
baiting the mousetrap with a brittle piece of bait mounted by and between the two hooks, the two hooks applying diametrically opposed tensile forces to the brittle piece of bait when the mousetrap is primed;
priming the mousetrap by locking a jaw of the mousetrap in an open position;
waiting for a mouse to chew or remove the brittle piece of bait; and
allowing the jaw to snap forward killing the mouse.

8. The method of claim 3, wherein the brittle piece of bait comprises a Cheerio.
